(19) United States
(12) Patent Application Publication
(10) Pub. No.: US 2024/0144452 A1
(43) Pub. Date: May 2, 2024

(54) APPARATUS AND METHOD WITH CONTAMINATION DETECTION OF CAMERA LENS

(71) Applicant: SAMSUNG ELECTRONICS CO., LTD., Suwon-si (KR)

(72) Inventors: Jaewook YOO, Suwon-si (KR); Youngwan SEO, Suwon-si (KR); Dokwan OH, Suwon-si (KR); Dasol HAN, Suwon-si (KR)

(73) Assignee: SAMSUNG ELECTRONICS CO., LTD., Suwon-si (KR)

(21) Appl. No.: 18/303,930

(22) Filed: Apr. 20, 2023

(30) Foreign Application Priority Data
Nov. 2, 2022 (KR) 10-2022-0144523

(51) Int. Cl. G06T 7/00; B60W 50/14; B60W 60/00; G06T 7/70

(52) U.S. Cl. CPC G06T 7/0002; B60W 50/14; B60W 60/0053; G06T 7/70; G06T 2207/20081; G06T 2207/20084; G06T 2207/30252

(57) ABSTRACT

An electronic device and method for detecting contamination of a camera lens, where the electronic device includes at least one camera configured to capture an image, a memory configured to store the image, and a contamination detection model configured to detect a contaminated portion of a lens of the at least one camera, in response to the image being input, and a processor configured to determine whether an operation of the electronic device is hindered by the contaminated portion, in response to the contamination detection model detecting the contaminated portion in the lens of the at least one camera.

### CROSS-REFERENCE TO RELATED APPLICATIONS

This application claims the benefit under 35 USC § 119(a) of Korean Patent Application No. 10-2022-0144523, filed on Nov. 2, 2022, in the Korean Intellectual Property Office, the entire disclosure of which is incorporated herein by reference for all purposes.

### BACKGROUND

### 1. Field

The following description relates to a device and method for detecting contamination of a camera lens.

### 2. Description of Related Art

Image analysis technology using an artificial intelligence model is being increasingly used for computer vision. In some examples, a deep learning model may be used as an artificial intelligence model for image analysis. The above description has been possessed or acquired by the inventor(s) in the course of conceiving the present disclosure and is not necessarily an art publicly known before the present application is filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided an electronic device including at least one camera configured to capture an image, a memory configured to store the image, and a contamination detection model configured to detect a contaminated portion of a lens of the at least one camera, in response to the image being input, and a processor configured to determine whether an operation of the electronic device is hindered by the contaminated portion, in response to the contamination detection model detecting the contaminated portion in the lens of the at least one camera.

The contamination detection model may include a model trained to detect a location of the contaminated portion within the image using a grid.

The processor may be configured to determine whether to supplement the contaminated portion with an overlapping area of another image captured by another camera, and to determine whether an operation of the electronic device is hindered by the contaminated portion based on the overlapping area of the another image.

The processor may be configured to update the contamination detection model based on a reference image obtained from the electronic device in an environment of use of the electronic device.

The processor may be configured to update the contamination detection model, using, as training data, the reference image and a label of the reference image determined based on an output of the contamination detection model to which the reference image is input.

The processor may be configured to preprocess the training data and to update the contamination detection model based on the preprocessed training data.

The electronic device may include a communication module configured to communicate with a server, wherein the server may be configured to receive reference images from each of a plurality of electronic devices, to update a super model using each of the reference images, and to update respective contamination detection models stored in each of the plurality of electronic devices using the updated super model, wherein the super model may include weights of all the contamination detection models included in each of the plurality of electronic devices, and wherein each of the respective contamination detection models may include a weight extracted from the super model to be used by the respective electronic device of the plurality of electronic devices.

The server may be configured to extract a weight of the contamination detection model of the electronic device from the super model before updating the contamination detection model of one of the plurality of electronic devices, and to learn the extracted weight using an image received from the electronic device.

In another general aspect, there is provided a method of operating an electronic device, the method including detecting a contaminated portion of a lens of at least one camera based on inputting an image of the at least one camera to a contamination detection model, and determining whether an operation of the electronic device is hindered by the contaminated portion, in response to the contamination detection model detecting the contaminated portion in the lens of the at least one camera.

The contamination detection model may include a model trained to detect a location of the contaminated portion within the image using a grid.

An accuracy of the contamination detection model increases, in response to an increase in a granularity of the grid.

The determining of whether the operation of the electronic device is hindered by the contaminated portion may include determining whether to supplement the contaminated portion with an overlapping area of another image captured by another camera, and determining whether an operation of the electronic device is hindered by the contaminated portion based on the overlapping area of the another image.

The method may include updating the contamination detection model based on a reference image obtained from the electronic device in an environment of use of the electronic device.

The updating of the contamination detection model may include updating the contamination detection model, using, as training data, the reference image and a label of the reference image determined based on an output of the contamination detection model to which the reference image is input.

The updating of the contamination detection model may include preprocessing the training data and updating the contamination detection model based on the preprocessed training data.

The method may include communicating, by the electronic device, with a server through a communication module, receiving, at the server, a reference image from each of a plurality of electronic devices, updating a super model, at the server, using each of the reference images, updating the respective contamination detection models stored in each of the plurality of electronic devices using the updated super model, wherein the super model may include weights of all the contamination detection models included in each of the plurality of electronic devices, and wherein each of the respective contamination detection models may include a weight extracted from the super model to be used by the respective electronic device of the plurality of electronic devices.

The method may include extracting a weight of the contamination detection model from the super model before updating the contamination detection model of the electronic device, and learning the extracted weight using an image received from the electronic device.

In another general aspect, there is provided an electronic device including at least one camera, and a processor configured to load a contamination detection model configured to detect a contaminated portion of a lens of the at least one camera, in response to an input of an image captured by the at least one camera to the contamination detection model, and determine whether a location of the contaminated portion in the lens of the camera hinders an operation of the electronic device, based on the location of the contaminated portion being provided by the contamination detection model using a grid, wherein the contamination detection model includes a convolution layer and is periodically updated for an environment in which the electronic device is used.

The electronic device may be installed in a vehicle, and the processor may be configured to terminate an autonomous driving mode of the vehicle, in response to determining that the contamination portion hinders the operation of the electronic device.

The processor may be configured to activate an output device to notify the user that the autonomous driving mode has terminated and to commence manual driving.

Other features and aspects will be apparent from the following detailed description, the drawings, and the claims.

### BRIEF DESCRIPTION OF THE DRAWINGS

FIG. 1 illustrates an example of an electronic device and a server.

FIG. 2 illustrates some examples of inference speed of a neural network model.

FIG. 3 illustrates an example of a contamination detection model.

FIGS. 4A and 4B illustrate examples of learning and updating a contamination detection model.

FIG. 5 illustrates an example of a server training a super model.

FIG. 6 illustrates an example of a server performing a fine tuning.

FIG. 7 illustrates an example of a method of detecting a contaminated portion of a lens of a camera.

FIG. 8 illustrates an example of a method of training one or more models.

FIG. 9 illustrates an example of an accuracy of a contamination detection model according to an update and a fine tuning of the contamination detection model.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, portions, or sections, these members, components, regions, layers, portions, or sections are not to be limited by these terms. Each of these terminologies is not used to define an essence, order, or sequence of corresponding members, components, regions, layers, portions, or sections, for example, but used merely to distinguish the corresponding members, components, regions, layers, portions, or sections from other members, components, regions, layers, portions, or sections. Thus, a first member, component, region, layer, portions, or section referred to in the examples described herein may also be referred to as a second member, component, region, layer, portions, or section without departing from the teachings of the examples.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing. As used herein, the term “and/or” includes any and all combinations of one or more of the associated listed items. For example, “A and/or B” may be interpreted as “A,” “B,” or “A and B.”

The terminology used herein is for the purpose of describing particular examples only and is not to be limiting of the examples. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, examples will be described in detail with reference to the accompanying drawings. When describing the examples with reference to the accompanying drawings, like reference numerals refer to like constituent elements and a repeated description related thereto will be omitted.

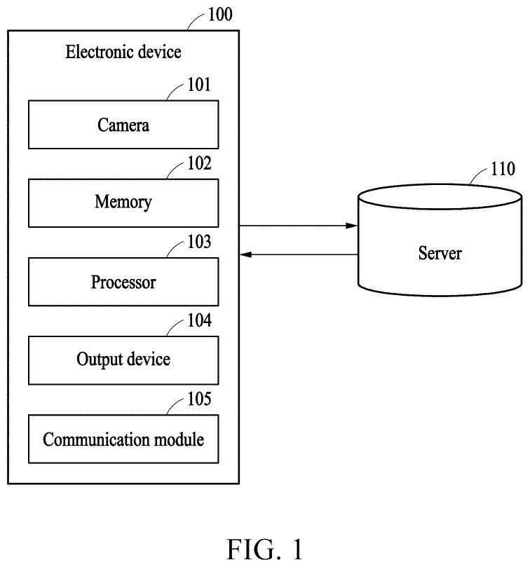

FIG. 1 illustrates an example of an electronic device and a server.

Referring to FIG. 1, an electronic device 100 and a server 110 are shown.

The electronic device 100 may include a camera 101, a memory 102, a processor 103, an output device 104, and a communication module 105.

In some examples, the electronic device 100 may include a camera 101. In other examples, the electronic device 100 may include more than one camera 101. Any reference to a camera 101 includes the presence of one camera 101 or more than one camera 101. The camera 101 may capture an external environment of the electronic device 100. The electronic device 100 may use an image captured by the camera 101. For example, when the electronic device 100 is, or is included in, a vehicle capable of performing autonomous or assisted driving, the vehicle may use images captured by the camera 101 for autonomous or assisted driving. For example, when the electronic device 100 is a smartphone which unlocks by recognizing a user's face, the smartphone may recognize the user's face by using images captured by the camera 101.

In some examples, the electronic device 100 may be a device which performs an operation by using an image captured by the camera 101. In some examples, the electronic device 100 may be incorporated in various computing devices such as a mobile phone, a smartphone, a tablet, an electronic-book (e-book) device, a laptop, a personal computer, a desktop, a workstation, or a server, various wearable devices such as a smart watch, smart glasses, or a head-mounted display (HMD), various home appliances such as a smart speaker, a smart TV, or a smart refrigerator, a smart kiosk, an internet of things (IoT) device, a walking assist device (WAD), a drone, or a robot, as devices utilizing an image captured by the at least one camera 101.

In another example, the electronic device 100 may be included in a vehicle. Hereinafter, a vehicle refers to any mode of transportation, delivery, or communication such as, for example, for example, an automobile, a truck, a tractor, a scooter, a motorcycle, a cycle, an amphibious vehicle, a snowmobile, a boat, a public transit vehicle, a bus, a monorail, a train, a tram, an autonomous vehicle, an unmanned aerial vehicle, a bicycle, a drone, and a flying object such as an airplane. In some examples, the vehicle may be, for example, an autonomous vehicle, a smart mobility, an electric vehicle, an intelligent vehicle, an electric vehicle (EV), a plug-in hybrid EV (PHEV), a hybrid EV (HEV), or a hybrid vehicle, an intelligent vehicle equipped with an advanced driver assistance system (ADAS) and/or an autonomous driving (AD) system.

According to some examples, when a lens of the camera 101 is contaminated, the operation of the electronic device 100 may be hindered. If the electronic device 100 operates incorrectly using an image in which contamination is present due to a contaminated lens of the camera 101, a problem may occur. For example, when the electronic device 100 is incorporated in a vehicle capable of performing autonomous driving, the vehicle may cut in between other vehicles, accelerate or decelerate using an image captured by the camera 101. If an autonomous vehicle fails to correctly detect an approaching vehicle due to the contaminated lens of the camera 101, an accident may occur.

In some examples, the electronic device 100 may detect a contaminated portion of a camera lens by using an image captured by the camera lens. In some examples, the electronic device 100 may detect the contaminated portion of the camera lens by using a contamination detection model. The contamination detection model may be a segmentation model trained to detect a contaminated portion of an image and the corresponding lens based on a grid. The contamination detection model may be stored in the memory 102 and be read by the processor 103.

In some examples, the electronic device 100 may determine whether a contamination that is detected by a contamination detection model is in an area of a lens which may hinder an operation of the electronic device 100. The electronic device 100 may determine whether the contaminated portion detected by the contamination detection model affects the operation of the electronic device 100. For example, if the electronic device 100 is a vehicle capable of autonomous driving, the vehicle may determine whether the contaminated portion has an influence on the autonomous driving by covering over or not detecting a vehicle driving on a lane of a road or on an adjacent road.

In some examples, if it is possible to supplement a loss caused by a contaminated portion of the lens by an overlapping portion of another image, the electronic device 100 may determine that the contaminated portion does not hinder an operation of the electronic device 100. In some examples, the overlapping portion of another image may be an image captured by another camera or a portion that may be sensed by a plurality of sensors (not shown).

In some examples, when a contaminated portion hinders an operation of the electronic device 100, the electronic device 100 may notify a user of the electronic device 100. For example, the electronic device 100 may provide the user with an alarm that an operation is not performable due to a contaminated camera lens, through a display (not shown). In some examples, the alarm may be output through the output device 104.

In some examples, when the contaminated portion hinders an operation of the electronic device 100, the electronic device 100 may itself remove the contamination. For example, the electronic device 100 may remove the contamination by using a wiper and/or washer fluid. In some examples, when a contaminated portion hinders an operation of the electronic device 100, the electronic device 100 may perform an alternative operation of the operation being hindered by the contaminated portion. For example, when the electronic device 100 is included in a vehicle performing autonomous driving and a contaminated portion hinders the autonomous driving of the vehicle, the vehicle may end the autonomous driving, inform the user that autonomous driving mode has ended, and perform an operation causing the user to drive manually.

At least one camera 101 may capture a still image or a video. In some examples, the camera 101 may include one or more lenses, image sensors, image signal processors, or flashes.

The memory 102 may store various pieces of data, which are used by at least one component of the electronic device 100. For example, the memory 102 may include an image captured by at least one camera 101 and a contamination detection model for detecting the contamination. In another example, the memory 102 may store a program (or an application, or software). The stored program may be a set of syntaxes that are coded and executable by the processor 103 to operate the electronic device 100. The memory 102 may include a volatile memory or a non-volatile memory.

The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), or an insulator resistance change memory. Further details regarding the memory 102 are provided below.

The processor 103 may control at least one other component of the electronic device 100 and perform processing of various pieces of data or computations. The processor 103 may control an overall operation of the electronic device 100 and may execute corresponding processor-readable instructions for performing operations of the electronic device 100. The processor 103 may execute, for example, software stored in the memory 102 to control one or more hardware components, such as, camera 101 of the electronic device 100 connected to the processor 103 and may perform various data processing or operations, and control of such components. In some examples, an operation of the electronic device 100 disclosed in this disclosure may be performed by the processor 103. For example, the processor 103 may detect a contaminated portion of an image captured by at least one camera 101, by using a contamination detection model.

The hardware-implemented data processing device 103 may include, for example, a main processor (e.g., a central processing unit (CPU), a field-programmable gate array (FPGA), or an application processor (AP)) or an auxiliary processor (e.g., a GPU, a neural processing unit (NPU), an image signal processor (ISP), a sensor hub processor, or a communication processor (CP)) that is operable independently of, or in conjunction with the main processor. Further details regarding the processor 103 are provided below.

The communication module 105 may support wired or wireless communication between the electronic device 100 and an external electronic device (e.g., the server 110). The electronic device 100 may transmit an image captured by at least one camera 101 through the communication module 105. The electronic device 100 may communicate with the server 110 through the communication module 105 to update a contamination detection model.

In some examples, the processor 103 may output through the output device 104, one or more of an image captured by the camera 101, information regarding a contaminated image, information to the user that autonomous driving mode has ended, information commanding the user to commence manual driving. In some examples, the output device 104 may provide an output to a user through auditory, visual, or tactile channel. The output device 104 may include, for example, a speaker, a display, a touchscreen, a vibration generator, and other devices that may provide the user with the output. The output device 104 is not limited to the example described above, and any other output device, such as, for example, computer speaker and eye glass display (EGD) that are operatively connected to the electronic device 104 may be used without departing from the spirit and scope of the illustrative examples described. In an example, the output device 104 is a physical structure that includes one or more hardware components that provide the ability to render a user interface, output information and speech, and/or receive user input.

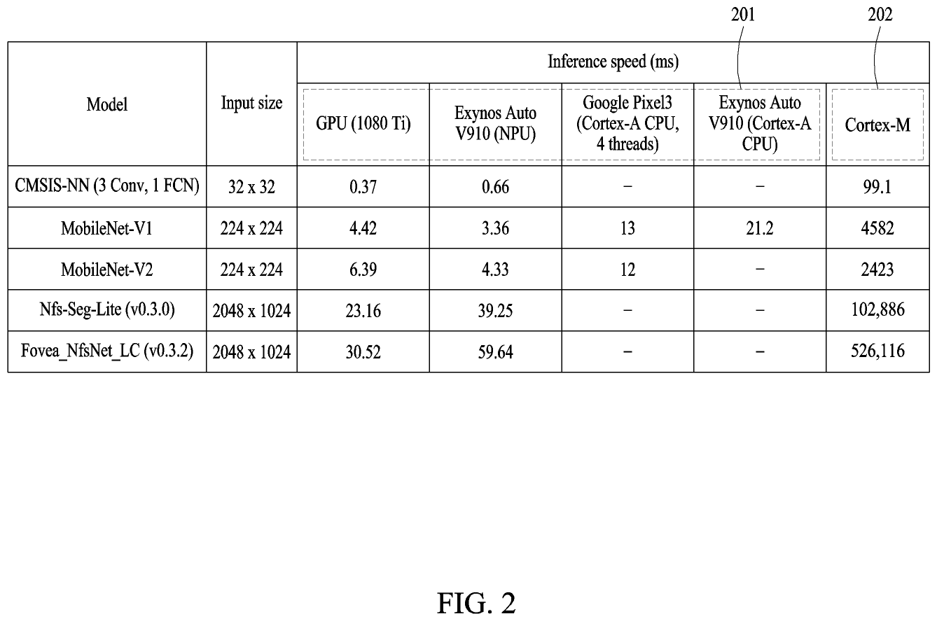

FIG. 2 illustrates some examples of inference speed of a neural network model.

Referring to FIG. 2, an inference speed of a target neural network model trained with high-performance hardware 201, can be power intensive, is shown.

A neural network model trained with the high-performance hardware 201 as a target may include neural networks such as, for example, a CMSIS-NN (common microcontroller software interface standard neural network), a MobileNet-V1, a MobileNet-V2, an Nfs-seg-Lite and a Fovea_NfsNet_LC. The high-performance hardware 201 may include processing devices such as, for example, a graphics processing unit (GPU), an Exynos Auto V910 (NPU), a Google Pixel 3, an Exynos Auto V910 (Cortex-A CPU), and an Exynos Auto V910. Low-performance hardware 202 may include processing devices such as, for example, a Cortex-M.

A resource environment of the low-performance hardware 202 may be a limited environment compared to a resource environment in which the high-performance hardware 201 learns a neural network model and uses the neural network model.

As illustrated in FIG. 2, an inference speed of the low-performance hardware 202, when using a neural network model trained with the high-performance hardware 201 as a target, is significantly less than that of the high-performance hardware 201. For example, for Fovea_NfsNet_LC, the inference speed may be 59.64 ms for the high-performance hardware 201 Exynos Auto V910 (NPU), but the inference speed may be 526,116 ms for the low-performance hardware 202 Cortex-M.

Therefore, a neural network model may be appropriate, which is used by the low-performance hardware 202 with a limited resource environment compared to the high-performance hardware 201.

In some examples, an electronic device (e.g., the electronic device 100 of FIG. 1) may be an edge device that directly performs data collection, analysis, and processing. The electronic device, which is an edge device, may have limitations in performance, depending on constraints such as a use environment. Accordingly, the electronic device may include the low-performance hardware 202 with a relatively limited resource environment compared to the high-performance hardware 201. The electronic device may include low-power hardware with a limited resource environment.

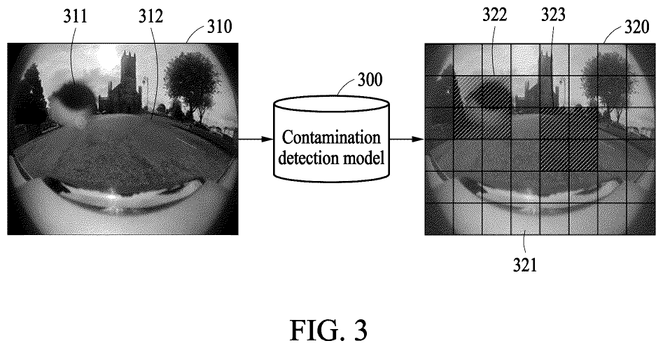

A neural network model that performs optimally in an electronic device including the low-performance hardware 202 with a limited resource environment is described below with reference to FIG. 3.

FIG. 3 illustrates an example of a contamination detection model.

Referring to FIG. 3, a contamination detection model 300 is shown. An electronic device may include the contamination detection model 300. An electronic device including low-power hardware with a limited resource environment may detect contaminated portions 322 and 323 of a camera lens by using the contamination detection model 300.

In some examples, an input image 310 captured by a camera of an electronic device, may include contaminations 311 and 312 caused by corresponding contaminations on a camera lens. Such lens contaminations may include water drops and mud that are deposited on the sensor lens when the camera is exposed to outdoor activities.

In some examples, the electronic device may detect contaminations 311 and 312 corresponding to contaminations on a camera lens by using the contamination detection model 300. When the input image 310 is input to the contamination detection model 300, an output image 320 may be output as a result of the input image 310 being processed by the contamination detection model 300.

In some examples, the output image 320 may include the contaminated portions 322 and 323, and a grid 321. The contaminated portions 322 and 323 may be partial areas of the grid 321 corresponding to locations of the contaminations 311 and 312 included in the input image 310. For example, the first contaminated portion 322 may be a partial area of a grid corresponding to a location of the first contamination 311. The second contaminated portion 323 may be a partial area of a grid corresponding to a location of the second contamination 312.

In some examples, the output image 320 may display the contaminated portions 322 and 323 having different colors on the display 104. The colors of the contaminated portions 322 and 323 may vary depending on the type of contamination. For example, the output image 320 may display contaminations from an opaque contaminant, such as mud, in red. The output image 320 may display transparent contaminations in green. The output image 320 may have semi-transparent contaminations in blue.

In some examples, the contamination detection model 300 may be a segmentation model for detecting the contaminated portions 322 and 323 caused by contaminations of a camera lens. The contamination detection model 300 may be a deep learning model detecting the contaminated portions 322 and 323 based on the grid 321. The contamination detection model 300 may be a model trained to detect the contaminated portions 322 and 323 caused by contaminations on a camera lens from the input image 310 by using the grid 321.

In some examples, the contamination detection model 300 may be a model that is configured to detect the contaminated portions 322 and 323 by a unit in which the contaminated portions 322 and 323 may be recognized. In some example, the unit is not a unit of pixels. Referring to FIG. 3, in some examples, the contamination detection model 300 is a model based on an 8×6 grid. In some examples, when a resolution of the grid 321, which corresponds to a size of the grid 321, increases, the contamination detection model 300 may detect the contaminated portions 322 and 323 more accurately. In other words, when the granularity of the grid 321 increases, the accuracy of the contamination detection model 300 may increase. However, when a resolution of the grid 321 increases, a computation speed may decrease. Accordingly, In some examples, the contamination detection model 300 may be a model that is trained with a different resolution of a grid 321. For example, when an electronic device is an autonomous vehicle driving on a highway, a fast computation speed is needed, so a contamination detection model 300 that is trained with a relatively low resolution of a grid may be used, compared to resolution of a model that is trained to be used when the vehicle is being driving on a general road. In another example, when an electronic device is an autonomous vehicle and is being parking, accurate detection of a contaminated portion is needed more than a fast computation speed, so the contamination detection model 300 trained with a relatively high resolution of a grid may be used, compared to a contamination detection model 300 that is trained for driving on a highway. In some examples, an electronic device may include a plurality of contamination detection models and may change and use the contamination detection model 300 depending on circumstances.

When a segmentation model uses an upsampling layer and/or a deconvolution layer, a parameter size, a computation size, and a feature size of the segmentation model may be relatively larger. Accordingly, it may be difficult to use a segmentation model as the segmentation model above in an electronic device including low-power hardware and/or low-performance hardware.

In some examples, the contamination detection model 300 may include one convolution layer. In some examples, the contamination detection model 300 may not include an upsampling layer and/or a deconvolution layer.

Hereinafter, training and updating the contamination detection model 300 is further described.

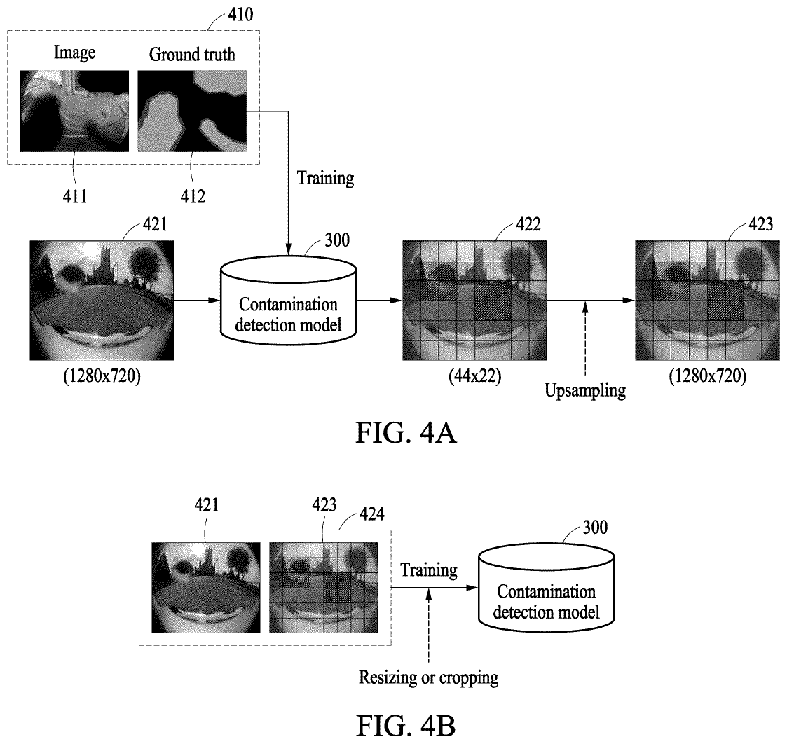

FIGS. 4A and 4B illustrate examples of learning and updating a contamination detection model.

FIG. 4A is a diagram illustrating training of a contamination detection model 300. FIG. 4B is a diagram illustrating updating for a personalization of the contamination detection model 300.

In some examples, the contamination detection model 300 may be a model trained by first training data 410. The first training data 410 may include an image 411 and ground truth 412. The image 411 may be an image including contamination. The ground truth 412 may be an image in which contamination and an uncontaminated area are marked from the image 411. The first training data 410 may be training data in which the ground truth 412 is labeled on the image 411.

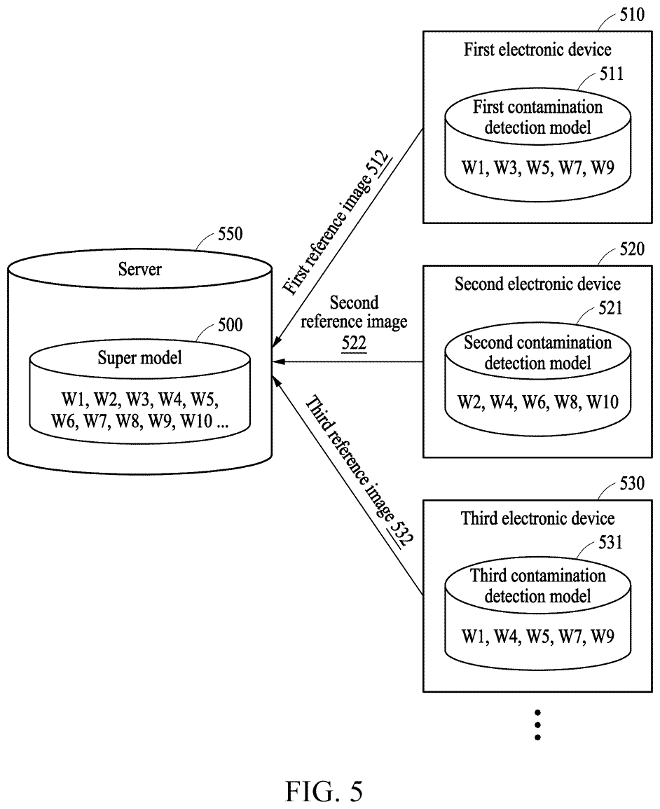

In some examples, training of the contamination detection model 300 using the first training data 410 may be performed in a server (e.g., the server 550 of FIG. 5 or the server 110 of FIG. 1). The contamination detection model 300 trained in a server may be applied to an electronic device, such as the electronic device 100.

In some examples, the contamination detection model 300 may output a result image 422 when a reference image 421 is input. In some examples, the reference image 421 is an image captured by a camera included in an electronic device, as an input. In some examples, a resolution of the reference image 421 may be 1280×720. In an example, since the contamination detection model 300 may include one convolution layer, a resolution of the result image 422 may be lower than that of the reference image 421. For example, the resolution of the result image 422 may be 44×22.

The contamination detection model 300 trained using the first training data 410 may be a universal model that is usable in all electronic devices described above. However, an environment in which an electronic device including the contamination detection model 300 is used may differ depending on the use of the electronic device. Accordingly, the contamination detection model 300 may be updated to better detect a contaminated portion of a camera lens in the environment in which the electronic device is being used.

The reference image 421 newly collected by an electronic device using a camera is generally not labeled with a ground truth. Therefore, to update the contamination detection model 300 with the reference image 421, the result image 422, which is output by inputting the reference image 421 to the contamination detection model 300 may be used.

In some examples, a result image 422, which has low resolution compared to the reference image 421, may be upsampled. The result image 422 may be upsampled to have the same resolution as the reference image 421. An upsampling image 423 may have the same resolution as the reference image 421.

In some examples, the contamination detection model 300 may be updated by using second training data 424 including a label in which the reference image 421 and the upsampling image 423 form a labeled pair. The upsampling image 423 of the second training data 424 may serve a similar purpose as the ground truth 412 of the first training data 410.

In some examples, the second training data 424 may be preprocessed. A preprocessed image may be an image generated by resizing and cropping the second training data 424. The electronic device may generate various pieces of training data by preprocessing the second training data 424.

In some examples, updating of the contamination detection model 300 by using the second training data 424 may be performed by a processor of an electronic device or a server (e.g., the server 110 of FIG. 1 or the server 550 of FIG. 5) communicating with an electronic device by wire and/or wirelessly. A processor or a server of an electronic device may update the contamination detection model 300 when the electronic device is in a standby mode.

By updating the contamination detection model 300 using the reference image 421 captured by an electronic device, the contamination detection model 300 may be updated to detect a contaminated portion that is suitable to an environment in which the electronic device is used. An accuracy of detecting the contaminated portion of the contamination detection model 300, which is updated to detect the contaminated portion suitably to the environment in which the electronic device is used, may increase.

Hereinafter, training of a super model, performed in a server, is further described.

FIG. 5 illustrates an example of a server training a super model. In addition to the description of FIG. 5 below, the descriptions of FIGS. 1-4 are also applicable to FIG. 5.

Referring to FIG. 5, a first electronic device 510, a second electronic device 520, a third electronic device 530, and a server 550 are shown.

The first electronic device 510, the second electronic device 520, and the third electronic device 530 may be instances of the electronic device 100 of FIG. 1. The server 550 may be an instance of the server 110 for FIG. 1. The first electronic device 510 may store a first contamination detection model 511. The second electronic device 520 may store a second contamination detection model 521. The third electronic device 530 may store a third contamination detection model 531. The first contamination detection model 511, the second contamination detection model 521, and the third contamination detection model 531 may be examples of the contamination detection model 300 of FIGS. 3, 4A, and 4B.

Contamination detection models stored in the first electronic device 510, the second electronic device 520, and the third electronic device 530 may be different models. For example, the first contamination detection model 511, the second contamination detection model 521, and the third contamination detection model 531 may have different weights for detecting a contaminated portion.

The server 550 may communicate with the first electronic device 510, the second electronic device 520, and the third electronic device 530 by wire and/or wirelessly. The server 550 may include a super model 500. The super model 500 may be a model including all the weights of the first contamination detection model 511, second contamination detection model 521, and third contamination detection model 531 stored in the first electronic device 510, second electronic device 520, and third electronic device 530, respectively. The first contamination detection model 511, second contamination detection model 521, and third contamination detection model 531 stored in the first electronic device 510, second electronic device 520, and third electronic device 530, respectively, may be models in which only weights that are needed for a corresponding electronic device are extracted from among weights included in the super model 500 and such extracted weights are provided to the respective electronic devices 510-530 for use as the individual contamination detection modules 511-531. That is, the first contamination detection model 511, second contamination detection model 521, and third contamination detection model 531 stored in the first electronic device 510, second electronic device 520, and third electronic device 530, respectively, may be submodels extracted from the super model 500 and provided to the electronic devices 510-530.

In some examples, the server 550 may periodically receive images captured by the first electronic device 510, second electronic device 520, and third electronic device 530. For example, the server 550 may periodically receive a first reference image 512, a second reference image 522, and a third reference image 532 from the first electronic device 510, second electronic device 520, and third electronic device 530 respectively.

In some examples, the server 550 may update the super model 500 using reference images received from the first electronic device 510, second electronic device 520, and third electronic device 530, respectively. The server 550 may train the super model 500 offline by using reference images received from the first electronic device 510, second electronic device 520, and third electronic device 530. A weight included in the super model 500 may be changed due to the update.

In some examples, the server 550 may update the first contamination detection model 511, second contamination detection model 521, and third contamination detection model 531 stored in the first electronic device 510, second electronic device 520, and third electronic device 530, respectively, using an updated super model 500. The server 550 may update weights of the first contamination detection model 511, second contamination detection model 521, and third contamination detection model 531 stored in the first electronic device 510, second electronic device 520, and third electronic device 530, respectively, using corresponding updated weights of the updated super model 500.

By updating a weight of the super model 500 included in the server 550, an accuracy of a contamination detection model using the weight may generally increase.

An updating of the super model 500 using the first reference image 512, second reference image 522, and third reference image 532 received from the first electronic device 510, second electronic device 520, and third electronic device 530, respectively, may be a universal update applicable to all electronic devices. Therefore, before updating the contamination detection model stored in the electronic device by using the super model 500, a fine tuning may be needed to extract and personalize a weight included in the corresponding contamination detection sub-model. Hereinafter, a fine tuning is described.

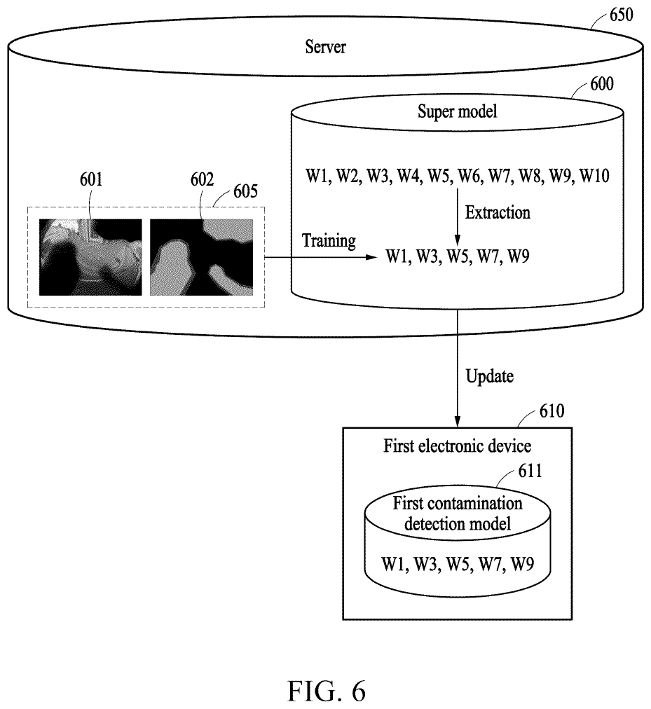

FIG. 6 illustrates an example of a server 650 performing a fine tuning. In addition to the description of FIG. 6 below, the descriptions of FIGS. 1-5 are also applicable to FIG. 6.

The server 650 may update the first contamination detection model 611 stored in the first electronic device 610 using the updated super model 600. The first electronic device 610 may be an instances of the electronic device 100 of FIG. 1, and the server 650 may be an instance of the server 110 for FIG. 1 or the server 550 of FIG. 5. A server may fine tune the first contamination detection model 611 to better detect contamination in an environment in which the first electronic device 610 is used.

In some examples, the server 650 may update a contamination detection model of any one of a plurality of electronic devices communicating with the server 650 by wire and/or wirelessly. For example, the server 650 may update the first contamination detection model 611 of the first electronic device 610 by sending updated weights from the server 650 by wire and/or wirelessly.

In some examples, the server 650 may extract a weight included in a contamination detection model to be updated, from the super model 600. For example, the server 650 may extract weights W1, W3, W5, W7, and W9 included in the first contamination detection model 611 (for example, based on an identity or trait of the first electronic device 510), which is a contamination detection model to be updated, from the super model 600. A weight extracted by the server 650 may be an updated weight, as a weight that has been learned (updated) from a plurality of reference images received from a plurality of electronic devices.

In some examples, the server 650 may learn an extracted weight using third training data 605. The server 650 may fine tune the extracted weight by using the third training data 605. The server 650 may update the extracted weight by using the third training data 605. The third training data 605 may be training data in which a reference image 601 received from an electronic device which will update a contamination detection model and ground truth 602 of the reference image 601 are labeled. For example, the reference image 601 received from an electronic device which will update a contamination detection model may be the first reference image 512 received from the first electronic device 510 of FIG. 5 and may be used as a training sample as described with reference to FIG. 5.

In some examples, the server 650 may update a contamination detection model of an electronic device using a weight learned by the third training data 605. For example, the server 650 may update the first contamination detection model 611 using a weight learned by the third training data 605.

The server 650 may better detect a contaminated portion of a lens in an environment in which an electronic device is used, by using the method of fine tuning a weight described above. The server 650 may personalize a contamination detection model by using the method of fine tuning a weight described above, to better detect a contaminated portion according to a user of an electronic device.

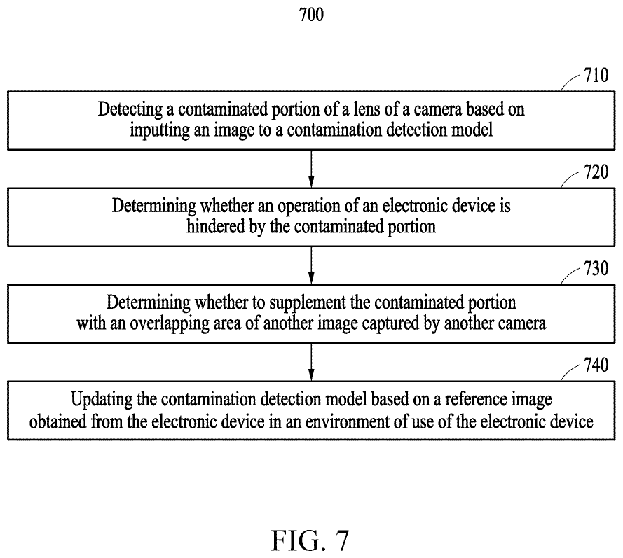

FIG. 7 illustrates an example of a method of detecting a contaminated portion of a lens of a camera. The operations of FIG. 7 may be performed in the sequence and manner as shown. However, the order of some operations may be changed, or some of the operations may be omitted, without departing from the spirit and scope of the shown example. Additionally, operations illustrated in FIG. 7 may be performed in parallel or simultaneously. One or more blocks of FIG. 7, and combinations of the blocks, can be implemented by special purpose hardware-based computer that perform the specified functions, or combinations of special purpose hardware and instructions, e.g., computer or processor instructions. For example, operations 710 through 740 may be performed by a computing apparatus (e.g., processor 103 or the server 110 of FIG. 1). In addition to the description of FIG. 7 below, the descriptions of FIGS. 1-6 are also applicable to FIG. 7 and are incorporated herein.

Referring to FIG. 7, in operation 710, the electronic device 100 may detect a contaminated portion of a lens of a camera based on inputting an image to a contamination detection model.

In operation 720, the electronic device 100 may determine whether an operation of an electronic device is hindered by the contaminated portion.

In operation 730, the electronic device 100 may determine whether to supplement the contaminated portion with an overlapping area of another image captured by another camera.

In operation 740, the electronic device 100 may update the contamination detection model based on a reference image obtained from the electronic device in an environment of use of the electronic device.

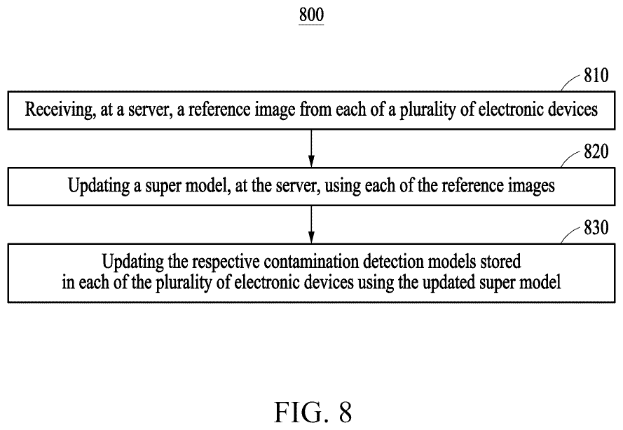

FIG. 8 illustrates an example of a method of training one or more models. In some examples, the method of training the models may be performed at a server. The operations of FIG. 8 may be performed in the sequence and manner as shown. However, the order of some operations may be changed, or some of the operations may be omitted, without departing from the spirit and scope of the shown example. Additionally, operations illustrated in FIG. 8 may be performed in parallel or simultaneously. One or more blocks of FIG. 8, and combinations of the blocks, can be implemented by special purpose hardware-based computer that perform the specified functions, or combinations of special purpose hardware and instructions, e.g., computer or processor instructions. For example, operations 810 through 830 may be performed by a computing apparatus (e.g., the server 550 of FIG. 5 or the server 110 of FIG. 1). In addition to the description of FIG. 8 below, the descriptions of FIGS. 1-7 are also applicable to FIG. 8 and are incorporated herein.

Referring to FIG. 8, in operation 810, the server, for example server 550 of FIG. 5, may receive a reference image from each of a plurality of electronic devices.

In operation 820, the server, for example server 550 of FIG. 5, may update a super model stored at the server, for examples super model 550 or super model 600, using each of the reference images.

In operation 830, the server, for example server 550 of FIG. 5, may update the respective contamination detection models stored in each of the plurality of electronic devices using the updated super model.

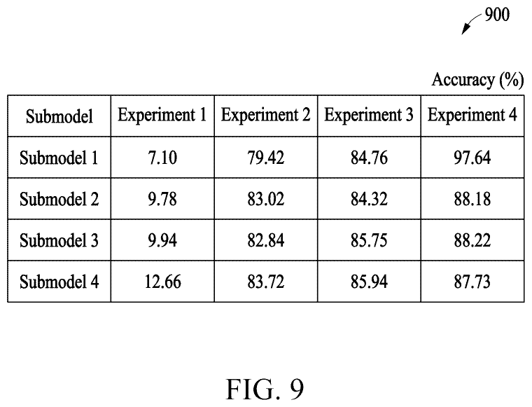

FIG. 9 illustrates an example of an accuracy of a contamination detection model according to an update and a fine tuning of the contamination detection model.

Referring to FIG. 9, a table 900 showing accuracy of submodels 1 to 4 in Experiments 1 to 4.

The submodels 1 to 4 may be models in which only some of the weights are extracted from among weights included in a super model (e.g., the super model 500 of FIG. 5).

Experiment 1 illustrates an example of an accuracy of a submodel when the submodel is simply extracted from a super model. Experiment 2 illustrates an example of an accuracy of a of a submodel when the update described with reference to FIGS. 4A and 4B is additionally performed on the submodel extracted in Experiment 1. Experiment 3 illustrates an example of an accuracy of a submodel extracted from a super model trained by the method described with reference to FIG. 5. Experiment 4 illustrates an example of an accuracy of a submodel when the fine tuning described with reference to FIG. 6 is additionally performed on the submodel extracted in Experiment 3.

Comparing Experiments 1 and 2, it may be confirmed that the accuracy increases by performing the update described with reference to FIGS. 4A and 4B. Comparing Experiments 2 and 3, it may be confirmed that the accuracy of the submodel extracted from the super model trained by the method described with reference to FIG. 5 is higher than that of the submodel on which only the update of Experiment 2 is performed. Comparing Experiments 3 and 4, it may be confirmed that an accuracy of a submodel may further increase if the fine tuning described with reference to FIG. 6 is additionally performed on the trained super model. Comparing Experiments 2 and 4, it may be confirmed that an accuracy of a submodel personalized through super model training and fine tuning may be higher than that of a submodel personalized through the update described with reference to FIGS. 4A and 4B.

The computing apparatuses, the electronic devices, the processors, the memories, and other components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in the figures that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An electronic device comprising:
at least one camera configured to capture an image;
a memory configured to store the image, and a contamination detection model configured to detect a contaminated portion of a lens of the at least one camera, in response to the image being input; and
a processor configured to determine whether an operation of the electronic device is hindered by the contaminated portion, in response to the contamination detection model detecting the contaminated portion in the lens of the at least one camera.

2. The electronic device of claim 1, wherein the contamination detection model comprises a model trained to detect a location of the contaminated portion within the image using a grid.

3. The electronic device of claim 1, wherein the processor is further configured to determine whether to supplement the contaminated portion with an overlapping area of another image captured by another camera, and to determine whether an operation of the electronic device is hindered by the contaminated portion based on the overlapping area of the another image.

4. The electronic device of claim 1, wherein the processor is further configured to update the contamination detection model based on a reference image obtained from the electronic device in an environment of use of the electronic device.

5. The electronic device of claim 4, wherein the processor is further configured to update the contamination detection model, using, as training data, the reference image and a label of the reference image determined based on an output of the contamination detection model to which the reference image is input.

6. The electronic device of claim 5, wherein the processor is further configured to preprocess the training data and to update the contamination detection model based on the preprocessed training data.

7. The electronic device of claim 1, further comprising:
a communication module configured to communicate with a server,
wherein the server is configured to receive reference images from each of a plurality of electronic devices, to update a super model using each of the reference images, and to update respective contamination detection models stored in each of the plurality of electronic devices using the updated super model,
wherein the super model comprises weights of all the contamination detection models comprised in each of the plurality of electronic devices, and
wherein each of the respective contamination detection models comprise a weight extracted from the super model to be used by the respective electronic device of the plurality of electronic devices.

8. The electronic device of claim 7, wherein the server is further configured to extract a weight of the contamination detection model of the electronic device from the super model before updating the contamination detection model of one of the plurality of electronic devices, and to learn the extracted weight using an image received from the electronic device.

9. A method of operating an electronic device, the method comprising:
detecting a contaminated portion of a lens of at least one camera based on inputting an image of the at least one camera to a contamination detection model; and
determining whether an operation of the electronic device is hindered by the contaminated portion, in response to the contamination detection model detecting the contaminated portion in the lens of the at least one camera.

10. The method of claim 9, wherein the contamination detection model comprises a model trained to detect a location of the contaminated portion within the image using a grid.

11. The method of claim 10, wherein an accuracy of the contamination detection model increases, in response to an increase in a granularity of the grid.

12. The method of claim 9, wherein the determining of whether the operation of the electronic device is hindered by the contaminated portion comprises
determining whether to supplement the contaminated portion with an overlapping area of another image captured by another camera, and
determining whether an operation of the electronic device is hindered by the contaminated portion based on the overlapping area of the another image.

13. The method of claim 9, further comprising:
updating the contamination detection model based on a reference image obtained from the electronic device in an environment of use of the electronic device.

14. The method of claim 13, wherein the updating of the contamination detection model comprises updating the contamination detection model, using, as training data, the reference image and a label of the reference image determined based on an output of the contamination detection model to which the reference image is input.

15. The method of claim 14, wherein the updating of the contamination detection model comprises preprocessing the training data and updating the contamination detection model based on the preprocessed training data.

16. The method of claim 9, further comprising:
Communicating, the electronic device, with a server through a communication module;
receiving, at the server, a reference image from each of a plurality of electronic devices;
updating a super model, at the server, using each of the reference images;
updating the respective contamination detection models stored in each of the plurality of electronic devices using the updated super model;
wherein the super model comprises weights of all the contamination detection models comprised in each of the plurality of electronic devices, and
wherein each of the respective contamination detection models comprises a weight extracted from the super model to be used by the respective electronic device of the plurality of electronic devices.

17. The method of claim 16, further comprising:
extracting a weight of the contamination detection model from the super model before updating the contamination detection model of the electronic device; and
learning the extracted weight using an image received from the electronic device.

18. An electronic device comprising:
at least one camera; and
a processor configured to
load a contamination detection model configured to detect a contaminated portion of a lens of the at least one camera, in response to an input of an image captured by the at least one camera to the contamination detection model, and
determine whether a location of the contaminated portion in the lens of the camera hinders an operation of the electronic device, based on the location of the contaminated portion being provided by the contamination detection model using a grid,
wherein the contamination detection model comprises a convolution layer and is periodically updated for an environment in which the electronic device is used.

19. The device of claim 18, wherein the electronic device is installed in a vehicle, and the processor is further configured to terminate an autonomous driving mode of the vehicle, in response to determining that the contamination portion hinders the operation of the electronic device.

20. The device of claim 19, wherein the processor is further configured to activate an output device to notify the user that the autonomous driving mode has terminated and to commence manual driving.
